(19) United States
(12) Patent Application Publication
(10) Pub. No.: US 2026/0095600 A1
(43) Pub. Date: Apr. 2, 2026

(54) METHOD AND ELECTRONIC DEVICE FOR COMPRESSING A VIDEO USING AI-BASED IN LOOP FILTER

(71) Applicant: SAMSUNG ELECTRONICS CO., LTD., Suwon-si (KR)

(72) Inventors: Anubhav SINGH, Bangalore (IN); Aviral AGRAWAL, Uttar Pradesh (IN); Raj Narayana GADDE, Bangalore (IN); Yinji PIAO, Suwon-si (KR); Minwoo PARK, Suwon-si (KR); Kwangpyo CHOI, Suwon-si (KR)

(73) Assignee: SAMSUNG ELECTRONICS CO., LTD., Suwon-si (KR)

(21) Appl. No.: 19/410,792

(22) Filed: Dec. 5, 2025

Related U.S. Application Data
(63) Continuation of application No. PCT/KR2024/007733, filed on Jun. 5, 2024.

(30) Foreign Application Priority Data
Jun. 6, 2023 (IN) 202341038884
May 8, 2024 (IN) 202341038884

(51) Int. Cl. H04N 19/86; G06V 10/40; G06V 10/60; G06V 10/77; G06V 20/40; H04N 19/117; H04N 19/159; H04N 19/172; H04N 19/196

(52) U.S. Cl. CPC H04N 19/86; G06V 10/40; G06V 10/7715; G06V 20/46; H04N 19/117; H04N 19/159; H04N 19/172; H04N 19/196; G06V 10/60

(57) ABSTRACT

Embodiments herein provide a method and an electronic device for compressing a video for AI-based in loop filter (AILF). The method includes obtaining a video comprising a plurality of frames, wherein each frame of the pluralities of frames comprises a plurality of channels. Further, the method includes extracting at least one feature from each frame of the plurality of frames of the video. Further, the method includes selecting, at least one pre-processor from the multi pre-processors for the AILF based on the at least one feature from each frame of the plurality of frames. Further, the method includes generating an encoded video by encoding the image information from each channel of the plurality of channels of each frame of the plurality of frames using the at least one selected pre-processor.

### CROSS-REFERENCE TO RELATED APPLICATIONS

This application is a bypass continuation application of International Application No. PCT/KR2024/007733, filed on Jun. 5, 2024, which claims priority to Indian Provisional Patent Application No. 202341038884, filed on Jun. 6, 2023, and Indian Patent Application No. 202341038884, filed on May 8, 2024, in the Indian Intellectual Property Office, the disclosures of which are incorporated by reference herein in their entireties.

### BACKGROUND

### 1. Field

The present disclosure relates to the field of video codec. More particularly proposed disclosure is related to a method and an electronic device for compressing a video AI-based in loop filter.

### 2. Description of Related Art

In the realm of digital multimedia, video compression technology plays a vital role in efficient storage and transmission. Video data is commonly managed and conveyed as a series of bit streams. To achieve substantial compression efficiency, conventional video compression encoders and decoders, also referred to as “CODECs,” generate a predictive reference picture for the picture being encoded. This encoding process entails representing the difference between the current picture and the predicted reference. The greater the correlation between the prediction and the current picture, the fewer bits are necessary for compressing an image, which ultimately improves the overall efficiency of the compression process. The creation of the most precise reference picture prediction is highly coveted.

Despite significant advancements in video compression technology, inherent limitations still persist. The AI based In Loop Filter, which employs a fixed ratio, struggles to keep pace with the ever-growing content, impeding the attainment of higher compression ratios and superior video quality. However, the Joint Video Experts Team (JVET) and Moving Picture Experts Group (MPEG), the standard bodies for video compression, are actively exploring the potential of artificial intelligence to enhance compression efficiency. This involves integrating AI into various stages of the video compression pipeline, such as prediction, transformation, quantization, and entropy processes.

The integration of Artificial Intelligence (AI) within the video compression process is currently under active consideration by a video compression standard body. This initiative demonstrates the vast potential of AI in transforming video compression processes. The standard body is striving to enhance the efficiency and performance of AI tools, with the ultimate goal of improving compression ratios, reducing data transmission bandwidth, and optimizing video quality. The usage of the AI in video compression is driven by the prospect of achieving superior compression technologies in the future. The AI tools employed in this process include neural network models, which are trained based on video data to make decisions on video compression.

### SUMMARY

Additional aspects will be set forth in part in the description which follows and, in part, will be apparent from the description, or may be learned by practice of the presented embodiments.

According to an aspect of the disclosure, a method for managing multi pre-processors for an AI-based In Loop Filter (AILF) in a video codec, including obtaining, by an electronic device, a video including a plurality of frames; extracting, by the electronic device, at least one feature from each frame of the plurality of frames; selecting, by the electronic device, at least one pre-processor from the multi pre-processors for applying the AILF based on the at least one extracted feature, generating, by the electronic device, an encoded video by encoding the image information from each channel of the plurality of channels using the at least one selected pre-processor; and transmitting, by the electronic device, the encoded video and an index corresponding to the at least one selected pre-processor to a decoder. Each frame of the plurality of frames including a plurality of channels and each channel of the plurality of frames includes image information. Each ratio of each set of ratios corresponds to each channel of the plurality of channels. Each pre-processor of the multi pre-processors includes a set of ratios.

The encoding of the image information from each channel using the at least one selected pre-processor includes dividing, by the electronic device, the obtained video into video blocks; performing intra prediction and inter prediction based on the video blocks; performing, by the electronic device, a transformation of the video blocks based on the intra prediction and the inter prediction; performing, by the electronic device, a quantization on the video blocks based on the intra prediction and the inter prediction; generating, by the electronic device, quantized coefficients for the video blocks based on the intra prediction and the inter prediction; reconstructing, by the electronic device, the video based on the quantized coefficients; performing, by the electronic device, in-loop filtering of the reconstructed video with the AILF to remove at least one artifact from the reconstructed video; and performing, by the electronic device, entropy coding to encode the filtered reconstructed video. The quantization divides the transformed video blocks and generates the quantized coefficients

The encoding of the image information from each channel using the at least one selected pre-processor includes embedding, by the electronic device, the set of ratios of the at least one selected pre-processor into the encoded image information; and inputting, by the electronic device, the encoded image information from each channel and the plurality of frames to the AILF.

The set of ratios for the at least one selected pre-processor is embedded in at least one of a sequence header, a picture header, a slice header, and a Coding Tree Unit (CTU) of each frame of the plurality of frames.

The plurality of channels includes a luma reconstruction, a prediction buffer, a boundary strength, a Quantization Parameter (QP) base, a QP Slice, and a block coding type.

The performing of the in-loop filtering of the reconstructed video with the AILF includes performing the AILF after at least one of Luma Mapping and Chroma Scaling (LMCS), deblocking filtering, Sample Adaptive Offsetting (SAO), Adaptive Loop Filtering (ALF), and Cross-Component Adaptive Loop Filtering (CC-ALF) is performed.

The at least one feature from each frame of the plurality of frames is pre-defined.

Each set of ratios is variable.

The at least one selected pre-processor is selected from the multi pre-processors based on a quality of the video and the index corresponding to the at least one selected pre-processor.

According to an aspect of the disclosure, a method for managing multi pre-processors for an AI-based In Loop Filter (AILF) in a video codec, including obtaining, by an electronic device, an encoded video and an index corresponding to at least one selected pre-processor; determining, by the electronic device, the at least one selected pre-processor for decoding the encoded video based on the index corresponding to the at least one selected pre-processor; and decoding, by the electronic device, the encoded video using a set of ratios of the at least one selected pre-processor.

The determining that the at least one selected pre-processor for decoding the encoded video is based on the quality of a video output.

According to an aspect of the disclosure, an electronic device for managing multi pre-processors for an AI-based In Loop Filter (AILF) in a video codec, including memory configured to store one or more instructions; and at least one processor including the multi pre-processors. The at least one processor is configured to execute the one or more instructions to cause the electronic device to: obtain a video including a plurality of frames; extract at least one feature from each frame of the plurality of frames; select at least one pre-processor from the multi pre-processors for applying the AILF based on the at least one extracted feature; generate an encoded video by encoding the image information from each channel of the plurality of channels using the at least one selected pre-processor; and transmit the encoded video and an index corresponding to the at least one selected pre-processor to a decoder. Each ratio of each set of ratios corresponds to the plurality of channels. Each pre-processor of the multi pre-processors includes a set of ratios. Each frame of the plurality of frames includes a plurality of channels and each channel of the plurality of channels includes image information.

The at least one processor is configured to execute the one or more instructions to cause the electronic device to: divide the obtained video into video blocks; perform intra prediction and inter prediction based on the video blocks; perform a transformation of the video blocks based on the intra prediction and the inter prediction; perform a quantization on the video blocks based on the intra prediction and the inter prediction; generate quantized coefficients for the video blocks based on the intra prediction and the inter prediction; reconstruct the video blocks based on the quantized coefficients; perform in-loop filtering of the reconstructed video with the AILF to remove at least one artifact from the reconstructed video; and encode the filtered reconstructed video through entropy coding. The quantization divides the transformed video blocks and the generates the quantized coefficients;

The at least one processor is configured to execute the one or more instructions to cause the electronic device to: embed the set of ratios of the at least one selected pre-processor into the encoded image information; and input the encoded image information from each channel and the plurality of frames to the AILF.

The set of ratios for the at least one selected pre-processor is embedded in at least one of a sequence header, a picture header, a slice header, and a Coding Tree Unit (CTU) of each frame of the plurality of frames.

The plurality of channels includes a luma reconstruction, a prediction buffer, a boundary strength, a Quantization Parameter (QP) base, a QP Slice, and a block coding type.

The performing of the in-loop filtering of the reconstructed video with the AILF includes performing the AILF after at least one of Luma Mapping and Chroma Scaling (LMCS), deblocking filtering, Sample Adaptive Offsetting (SAO), Adaptive Loop Filtering (ALF), and Cross-Component Adaptive Loop Filtering (CC-ALF) is performed.

The at least one feature from each frame of the plurality of frames is pre-defined.

Each set of ratios is variable.

The at least one selected pre-processor is selected from the multi pre-processors based on a quality of the video and the index corresponding to the at least one selected pre-processor.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram that illustrates an exemplary video compression architecture;

FIG. 2 is illustrates exemplary extracted feature maps from a video;

FIG. 3A is a block diagram that illustrates electronic device with an assemblage block controller for the video compression according to an embodiment;

FIG. 3B is a block diagram that illustrates the assemblage block controller according to an embodiment;

FIG. 4A is a block diagram that illustrates the multiple pre-processors selector with backbone network for the video compression according to an embodiment;

FIG. 4B is a block diagram that illustrates the multiple pre-processors selector with backbone network for the video compression according to an embodiment;

FIG. 4C is a block diagram that illustrates a backbone network according to an embodiment;

FIG. 5 is a block diagram that illustrates a Versatile Video Codec (VVC) decoder with AILF according to an embodiment;

FIG. 6 is a block diagram that illustrates encoder for the VVC according to an embodiment;

FIG. 7 is a block diagram that illustrates video compressor architecture including unique pre-processors and the backbone network according to an embodiment;

FIG. 8 is a block diagram that illustrates an encoder and a decoder with the pre-processor for video codec according to an embodiment;

FIG. 9A is a block diagram that illustrates an exemplary encoder for a codec according to an embodiment;

FIG. 9B is a block diagram that illustrates an exemplary encoder for a codec according to an embodiment;

FIG. 9C is a block diagram that illustrates an exemplary encoder for a codec according to an embodiment;

FIG. 10 is a block diagram that illustrates an exemplary decoder for a codec according to an embodiment;

FIG. 11A illustrates an image frame with a Coding Tree Unit (CTU) and slice numbers according to an embodiment;

FIG. 11B is a block diagram that illustrates the extracted feature maps with indices according to an embodiment;

FIG. 12 is a flow diagram illustrating a method for compressing the video using an AI model according to an embodiment;

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### DETAILED DESCRIPTION

The principal object of the embodiments herein is to a method and an electronic device for compressing a video for AI based In Loop Filter (AILF).

Another object of the embodiments herein is to create a hybrid codec model through the utilization of the AILF. This innovative filter can be positioned at any point within the conventional in-loop filter, and its placement is crucial in ensuring the production of high-quality compressed video.

Another object of the embodiments herein is to utilize multiple pre-processors with varying channel ratios, which are allocated to each channel of the pre-processor. The optimal pre-processor is then chosen from this selection based on the channel ratios for both compressing and decompressing the video.

Another object of the embodiments herein is to provide optimal set of ratios of the at least one selected pre-processor is embedded in at least one of a sequence header, a picture header, a slice header, and a Coding Tree Unit (CTU) of each frame of the plurality of frames.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples are not be construed as limiting the scope of the embodiments herein.

As is traditional in the field, embodiments are described and illustrated in terms of blocks that carry out a described function or functions. These blocks, which referred to herein as managers, units, modules, hardware components or the like, are physically implemented by analog and/or digital circuits are logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports are printed circuit boards and the like. The circuits constituting a block be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings are used to help easily understand various technical features and it is understood that the embodiments presented herein are not limited by the accompanying drawings. As such, the proposed method is construed to extend to any alterations, equivalents and substitutes in addition to those which are particularly set out in the accompanying drawings. Although the terms first, second, etc. used herein to describe various elements, these elements are not be limited by these terms. These terms are generally used to distinguish one element from another.

Accordingly, the embodiment herein a method for compressing a video using multi pre-processors for an AILF in a video codec. The method includes receiving a video comprising a plurality of frames, wherein each frame of the pluralities of frames comprises a plurality of channels, before applying to an Artificial Intelligence (AI) model. Each of the channels having image information to be encoded by an encoder of the electronic device. Further, the method includes extracting at least one feature from each frame of the plurality of frames of the video. Further, the method includes selecting at least one pre-processor from the multi pre-processors for applying the AILF to enhance the encoding the image information based on the at least one feature from each frame of the plurality of frames, wherein each pre-processor of the multi pre-processors comprises a set of ratios each of which corresponds to each channel of the plurality of frames of each frame of the plurality of frames, and wherein the at least one selected pre-processor comprises an optimal set of ratios for encoding the image information from each channel. The method includes generating an encoded video by encoding the image information from each channel of the plurality of channels of each frame of the plurality of frames using the at least one selected pre-processor for the AILF. The method incudes transmitting the encoded video and an index corresponding to the at least one selected pre-processor to a decoder of the electronic device.

Accordingly, the embodiment herein an electronic device for managing multi pre-processors for the AILF in a video codec. The electronic device includes the multi pre-processors connected to an encoder and a decoder, a memory comprising a video to be encoded and an assemblage block controller (314) assemblage block controller, coupled to the memory and the multi pre-processors. Further, the assemblage block controller receive the video comprising a plurality of frames. Each of the frames includes a plurality of channels before applying the AILF. Each of the channels having image information to be encoded by an encoder of the electronic device. Further, the assemblage block controller extract at least one feature from each frame of the plurality of frames of the video. Further, the assemblage block controller selects at least one pre-processor from the multi pre-processors for encoding the image information based on the at least one feature from each frame of the plurality of frames. Each of the multi pre-processors includes a set of ratios each of which corresponds to each channel of the plurality of frames of each frame of the plurality of frames. Further the selected pre-processor comprises an optimal set of ratios for encoding the image information from each channel. The assemblage block controller generates an encoded video by encoding the image information from each channel of the plurality of channels of each frame of the plurality of frames using the at least one selected pre-processor. The assemblage block controller transmits the encoded video and an index corresponding to the at least one selected pre-processor to a decoder of the electronic device.

In the existing system, the optimization of video compression while enhancing its quality is achieved through a sophisticated video compression architecture. This architecture comprises a pre-processor equipped with a backbone network, tailored for an AILF or AI model. The AILF employs a Convolutional Neural Network (CNN) to execute the video compression process. By learning from data, the CNN proves to be highly effective in identifying patterns in images, recognizing object classes, and categorizing images. Moreover, CNNs are also leveraged for classifying audio, time-series, and signal data.

The CNN extracts a feature from a video frame using a fixed feature extraction layer. Input channels, including luma reconstruction, prediction buffer, boundary strength, quantization parameter (QP) base, QP s

Slice, partition average, reconstructed prediction, and block coding types, are utilized in the process. Each selected input channel is assigned a fixed channel ratio, with luma reconstruction, reconstruction, prediction buffer, QP, and boundary strength assigned ratios of 192, 24, 12, 48, and 48, respectively. The extracted feature is then passed to the backbone network, which is pre-processed with fixed channel ratios. However, this pre-processing method ignores the importance of specific feature characteristics and results in suboptimal use of input channels, leading to a higher network complexity due to redundant features.

The proposed solution offers a novel approach to compressing video, distinct from conventional systems and methods. By utilizing multiple detachable pre-processors with varying input channel ratios, the system can effectively learn and extract features from the video's image. The backbone network is trained with these pre-processors, ultimately selecting one for encoding based on either a heuristic method or the pre-processor that yields the optimal results in terms of Bitrate and Quality metrics. Quality is measured using Peak Signal-to-Noise Ratio (PSNR) and other ratios, with higher PSNR indicating better compressed or reconstructed image quality. The selected pre-processor is then signaled to a decoder with an index, allowing for decoding of the encoded images into a bit stream of high quality.

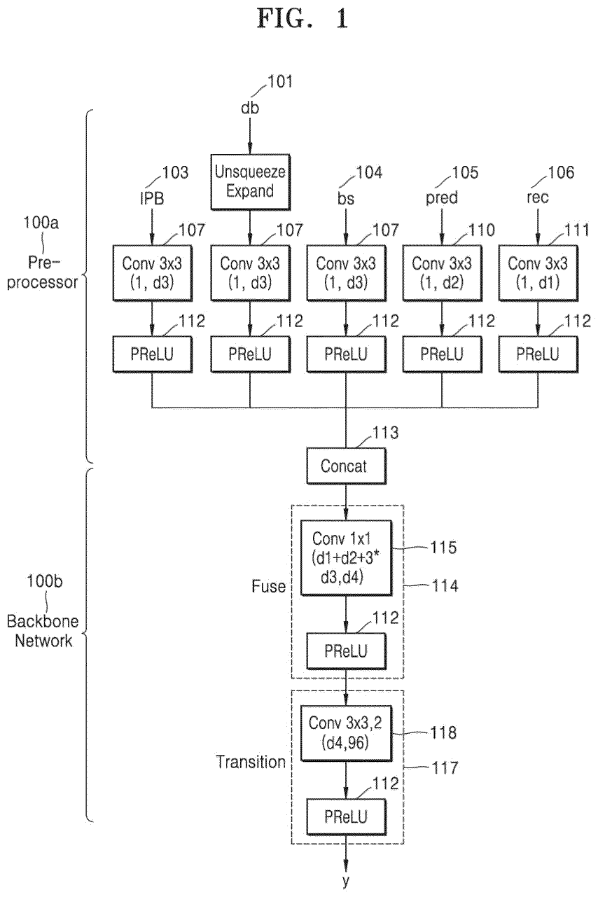

Presented in FIG. 1 is a block diagram showcasing an exemplary video compression architecture. Within this architecture, the pre-processor (100a) and the backbone network (100b) play integral roles. The pre-processor (100a) comprises of a convolution layers set and a series of Parametric Rectified Linear Unit (PRELU) layers (112). Meanwhile, the backbone network (100b) incorporates both a fuse technique (114) and a transition technique (117). The combination of these two components, the pre-processor (100a) and the backbone network (100b), effectively facilitates the AILF.

The input channels, carrying information from the frames of the video, are received by the pre-processor (100a) and undergo processing before being sent to the backbone network (100b). The pre-processor determines and assigns ratios to each input channel, based on their suitability for enhancing video quality. These ratios, including but not limited to d1, d2, d3, d4, d5, and d6, are fixed and non-variable. The selected input frame of the video and these ratios are then processed through convolution layers with various filtering options. Finally, the processed output is transmitted through the backbone network (100b) to compress the video without any compromise to its quality.

In FIG. 1, an unsqueeze expand (102) is depicted as receiving a distinct buffer (DB) (101) as input, which is assigned a ratio of d1 by the pre-processor. The unsqueeze expand (102) then expands the channel dimensions of DB (101). Subsequently, a first Conv 3×3 (1 d3) layer (107) receives input from the unsqueeze expand (102) and applies a 3×3 filter to extract features. Similarly, other inputs, such as an Inter Prediction Block (IPB) (103), a base signal (BS) (104), a prediction (pred) (105), and a reconstruction (rec) (106), are received with ratios of d3, d3, d2, and d1, respectively, as defined by the pre-processor. The inputs with assigned ratios are processed through convolution layers, such as the second Conv 3×3 (1 d3) layer (107), third Conv 3×3 (1 d3) layer (107), Conv 3×3 (1 d2) layer (110), and Conv 3×3 (1 d1) layer (111). These convolution layers utilize 3×3 filtering to provide blur-free sharpening or feature extraction from the inputs. The output of these convolutional layers (107, 110, and 111) is then passed through their respective PRELU layers (112), which apply a parametric RELU activation function to capture nuanced features and patterns for enhancing video compression ability. Finally, the output of the PRELU layer (112) is passed through the backbone network (100b).

The concatenated output from the concat layer (113) is received by the backbone network (100b) and undergoes a series of techniques to enhance its efficiency. The fuse technique (114) comprises a Conv 1×1 (d1+d2+3*d3 d4) layer (115) and a PRELU layer (112), which work together to reduce the dimensionality of the data and apply an activation function for non-linearity. The Conv 1×1 (d1+d2+3*d3 d4) layer (115) applies a filter to the concatenated input channels ratios, compressing the data for optimal processing. The output from this layer then passes through the PRELU layer (112) to determine non-linearity. Finally, the output from the fuse technique (114) is passed to the Conv 3×3 2 (d4 96) layer (118), which applies a 3×3 convolutional filter to the previous layer's output, down-samples the data by a factor of 2 in both width and height dimensions, and further reduces the data's dimensionality.

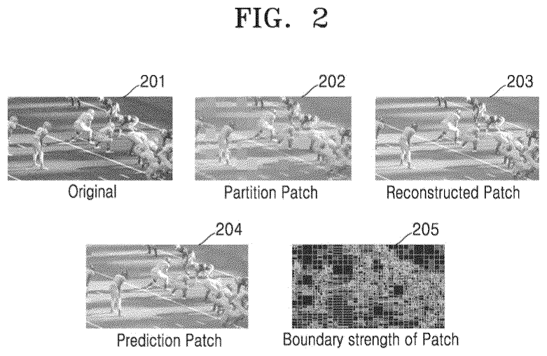

FIG. 2 is illustrates extracted feature maps from a video, according to prior art disclosed herein. The video yields feature maps for an original patch (201), a partition patch (202), a reconstructed patch (203), a prediction patch (204), and the boundary strength of a patch (205). These extracted features serve as inputs to the pre-processor, which processes them to derive the optimal output based on the most fitting feature patch.

The original patch (201) comprises unrefined and unprocessed video data extracted from the source. This patch (201) serves as the fundamental reference point for the subsequent stages of processing.

The partition patch (202) is extracted from the video. The partition map the encoder has decided based on Rate Distortion Optimization (RDO).

The reconstructed patch (203) is the outcome of a process that involves utilizing information from various patches, including but not limited to the partition patch (202) and prediction patch (204), to generate a refined version of the original patch (201) from the video bit stream.

The prediction patch (204) comprises a forecast of the original patch (201) derived from pertinent information found in the original patch (201). This process may entail utilizing data from adjoining patches in frames of the video. The precision of the prediction amplifies the excellence of the reconstructed patch (203).

The patch (205) boundary strength denotes a measure of confidence in the precision of patch boundaries. This parameter is utilized in object detection, segmentation, and motion estimation. A high value of boundary strength signifies a robust separation between distinct regions in the reconstructed patch (203).

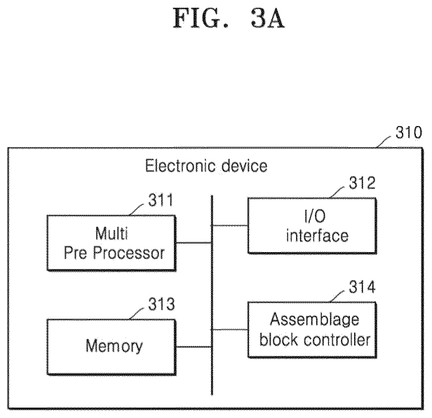

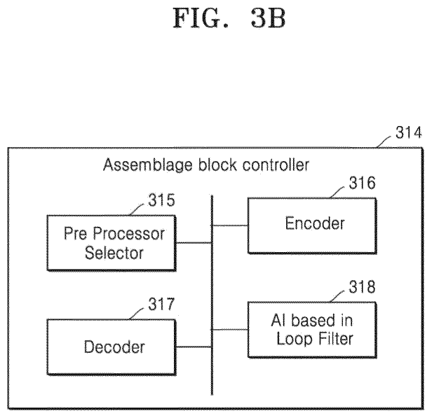

FIG. 3A is a block diagram that illustrates electronic device with an assemblage block controller for video compression, according to the embodiment disclosed herein. The electronic device (310) comprises a multitude of pre-processors (311), an I/O interface (312), a memory (313), and an assemblage block controller (314).

The electronic device (310) incorporates an assemblage block controller (314) to compress video. In addition, the electronic device (310) includes multi pre-processors (311) that communicate with the memory (313), the I/O interface (312), and the assemblage block controller (314). These multi pre-processors (311) execute instructions stored in the memory (313) to perform a range of processes. They may include one or several processors, including general-purpose processors such as a central processing unit (CPU) or an application processor (AP), graphics-only processing units like a graphics processing unit (GPU) or a visual processing unit (VPU), and/or artificial intelligence (AI) dedicated processors such as a neural processing unit (NPU).

Further, the memory (313) of the electronic device (310) includes storage locations to be addressable through the multi pre-processors (311). The memory (313) is not limited to a volatile memory and/or a non-volatile memory. Further, the memory (313) can include one or more computer-readable storage media. The memory (313) can include non-volatile storage elements. For example, non-volatile storage elements can include magnetic hard discs, optical discs, floppy discs, flash memories, or forms of electrically programmable memories (EPROM) or electrically erasable and programmable (EEPROM) memories. The memory (313) is capable of storing quantized coefficients for each frame of a video, along with pre-processor numbers assigned to each pixel value. This includes various values for each frame such as sequence header, picture header, slice header, slice numbers, and index numbers of the pre-processor. Additionally, the memory (313) stores ratios assigned to each input channel of the multi pre-processors (311), which are related to luma reconstruction, prediction buffer, boundary strength, QP base, QP slice, and block coding type. The memory (313) may store one or more instructions for operations performed by at least one processor.

The I/O interface (312) transmits the information between the memory (313) and external peripheral devices. The peripheral devices are the input-output devices associated with the electronic device (310). The I/O interface (312) receives the information from the memory (313) and the multi pre-processors (311). The I/O interface (312) communicates with the assemblage block controller (314) to fetch the data and process for the selection of the multi pre-processors (311).

Although not explicitly shown in the FIG. 3A, the electronic device may include at least one processor. The at least one processor may execute one or more instructions stored in memory, and the at least one processor may include at least one of controller, an assemblage block controller, and multi pre-processors.

The assemblage block controller (314) is a cutting-edge hardware that incorporates both analog and digital circuits, including logic gates, integrated circuits, microprocessors, microcontrollers, memory circuits, passive and active electronic components, as well as optical components. It interfaces with the I/O interface (312) and memory (313) to receive ratios from the multi pre-processors (311) and stored data from the memory (313) that is configured to accommodate a video comprising multiple frames, each of which consists of various channels containing image information to be encoded by an encoder of the electronic device (310). Moreover, the assemblage block controller (314) extracts at least one feature from each frame of the video and selects at least one pre-processor from a group of multi pre-processors (311) based on the extracted features. Each pre-processor within the multi pre-processors (311) has a set of ratios that correspond to individual channels within every frame of the video. The chosen pre-processor is distinguished by an optimal set of ratios designed for the encoding of image information from each channel. The assemblage block controller (314) then generates an encoded video by encoding the image information from each channel of the frames of the video using the selected pre-processor. Finally, it transmits the encoded video and an index corresponding to the selected pre-processor to a decoder (317) of the electronic device (310).

The assemblage block controller (314) encodes the image information from each channel of every frame in the plurality of frames across multiple channels. The incoming video is then segmented into distinct blocks for intra prediction technique (610) and inter prediction technique (512). Transformation and quantization are applied to the video blocks based on the intra prediction technique (610) and the inter prediction technique (512) to produce quantized coefficients for the segmented video blocks that have undergone both the intra prediction technique (610) and the inter prediction technique (512). The assemblage block controller (314) then reconstructs the video frames using the generated quantized coefficients. The reconstructed video is passed through the AILF (318) model for artifact removal, resulting in an artifact-free video. The assemblage block controller (314) of the assemblage block employs a selected pre-processor to generate a feature map for back bone of the AILF. Finally, the artifact-free reconstructed video is passed through entropy coding for encoding.

Moreover at the decoder, the assemblage block controller (314) receives the encoded video and its associated index, pertaining to the chosen pre-processor. Subsequently, the controller uses this index to identify the selected pre-processor for decoding the encoded video. Further, the assemblage block controller (314) determines the most suitable set of ratios for the selected pre-processor, based on the index, and utilizes this optimal set of ratios for decoding the encoded video. Additionally, the assemblage block controller (314) incorporates the optimal set of ratios of the chosen pre-processor into the encoded image information, to be utilized by the decoder (317) for decoding the encoded video. Finally, the pre-processed image information from each channel and frame is inputted into an in-loop filter to generate the encoded video.

FIG. 3B is a block diagram that illustrates the assemblage block controller, according to the embodiment disclosed herein. The assemblage block controller (314) includes a pre-processor selector (315), an encoder (316), a decoder (317), and the AILF (318). The pre-processor selector (315) chooses the optimal pre-processor from the multi pre-processors (311) by considering both the quality of the video output and the pre-processor's index number.

Meanwhile, for convenience of explanation, the encoder and decoder are expressed as being stored in an electronic device, but this is not limited to the disclosed example. For example, the operation of transmitting from an encoder to a decoder may include an operation of transmitting from an encoder of the electronic device to a decoder of another electronic device. It may also include operations transmitted from the encoder to the decoder within one electronic device.

Each pre-processor within the multi pre-processors (311) is equipped with several input channels that carry video frame information. Prior to being sent to the backbone network (419), this information is processed by the pre-processor's input channels, which are assigned various ratios, including but not limited to d1, d2, d3, d4, d5, and d6. These ratios may be adjusted as needed.

The input channels themselves include an IPB (103), a QP Slice (401), a QP Base (402), a BS (104), a pred (105), and a rec (106), each of which is processed by convolution layers with different filtering options, such as Conv 3×3, Conv 3×1, Conv 1×3, and Conv 1×1. These convolution layers serve to eliminate blurring, sharpen details, and extract features from each input channel.

The processed output is then passed through the PRELU layer (112), which performs a threshold operation based on the provided ratios and applies scaling coefficients to the input when it falls below the threshold or is zero. The PRELU layer (112) captures nuanced features and patterns from the input channels, potentially enhancing video compression quality.

An index is generated for each pre-processor within the multi pre-processors (311) to determine which pre-processor provides the optimal output based on the assigned ratios and is suitable for the video bitstream. The encoder (316) selects the processed information of the video frame based on the selected pre-processor and encodes it before sending it to the bitstream.

The pre-processor selector (315) expertly chooses the most optimal pre-processor from the multi pre-processors (311) and transmits the index of this chosen pre-processor to the decoder (317). The output of this selected pre-processor is then passed through Conv 2 3×3 C (418), which expertly utilizes a 3×3 convolutional filter for down-sampling operations and produces an output with a specific number of channels C. This output then proceeds to the PRELU layer (440), which applies a parametric RELU activation function to determine non-linearity and captures features and patterns for potentially enhancing video compression ability. Finally, the output passes through the backbone network (419).

The backbone network (419) comprises convolution layers with various filtering functions and channels, such as Conv 1×1 C×C1 (411), Conv 3×1 C×C21 (412), and Conv 1×3 C21×C22 (413). These convolution layers (411, 412, and 413) process the provided data and pass it through the PRELU layer (450). The data processed by the PRELU layer (112) is then passed through Conv 1×1 (C1+C22)×C (414), Conv 1×3 C×C31 (415), and Conv 3×1 C31×C (416) for further processing. The [c h w] (417) is then used to determine the number of channels or depth, height, and width of each frame of the video.

Once the backbone network (419) processes and extracts the required information, it passes through another convolution network, Conv 3×3 (420), for feature extraction, followed by the PRELU layer (460) for introducing adaptability. Subsequently, a second convolutional layer with Conv 3×3 6 layer (421) is employed for continuous feature extraction. The processed output from the Conv 3×3 6 (421) is then passed through the crop technique (423), which involves extracting a specific region from the input. Pixel shuffling (422) is then employed, potentially for tasks like super-resolution or color space transformation.

The Rec UV operation (424) signifies the reconstruction of color information, the U and V Chroma channels, followed by another crop technique (426). The final step involves the reconstruction of the luminance channel (Rec Y) (425).

The decoder (317) decodes the provided encoded frames of the video by using the selected pre-processor. The decoder (317) process the encoded frames of the video through an inverse quantization technique (502), an inverse transform technique (503), and the inverse prediction. The decoder (317) uses the AILF (318) generates only one artefact removed reconstructed frame to bit stream the video.

The AILF (318) is used in the encoder (316) and decoder (317) to process the input channels for encoding, selecting the optimal pre-processor. Further, decoding the encoded video and decoding the encoded data to bit stream the video on the display. The encoded video is passed through the AILF (318) reduces artefacts and improve the visual quality of the video. The AILF (318) operates by smoothing out discontinuities or artefacts that may arise during the compression and decoding process. The AILF processed decoded quality video is stored in the memory by the decoded picture buffer technique (608).

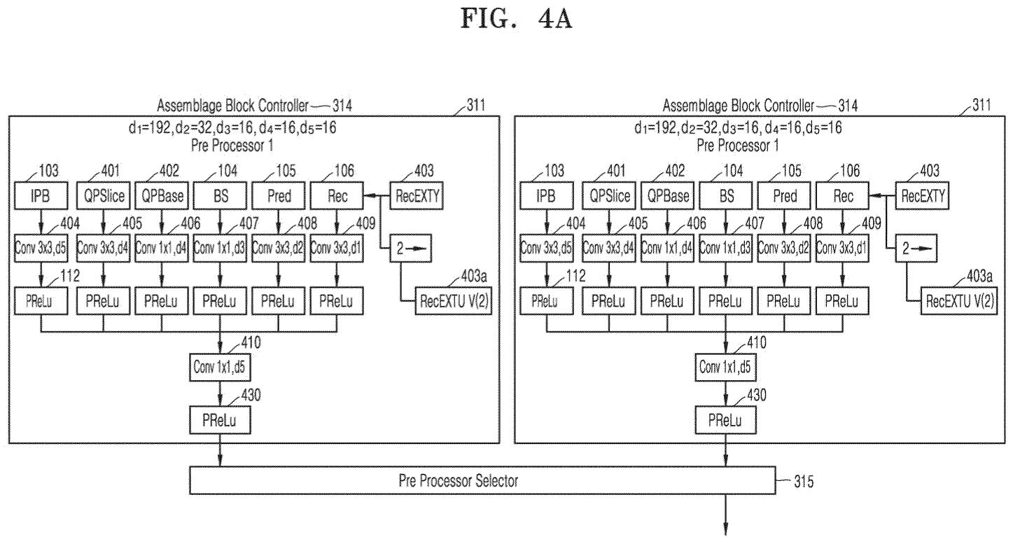

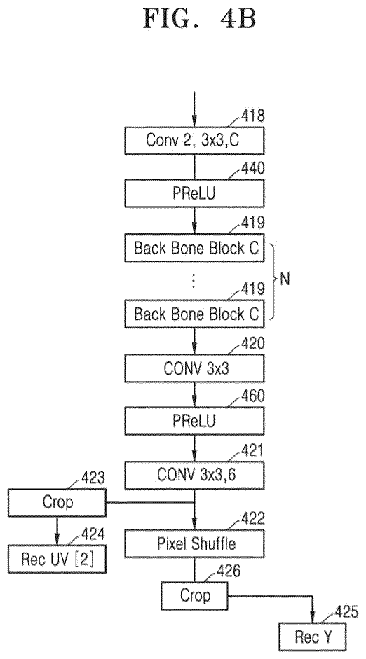

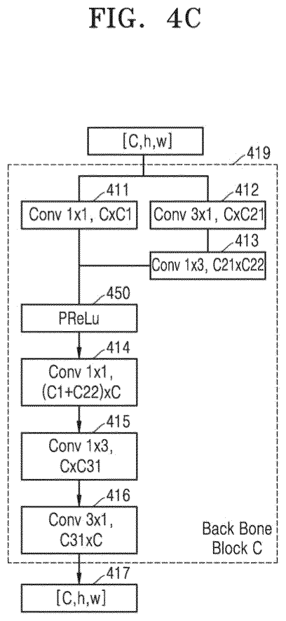

FIG. 4A is a block diagram that illustrates the multiple pre-processors selector with backbone network for the video compression, according to the embodiment disclosed herein. FIG. 4B is also a block diagram that illustrates the multiple pre-processors selector with backbone network for the video compression, according to an embodiment disclosed herein.

FIG. 4A shows the assemblage block controller (314) includes the multi pre-processors (311) and the pre-processor selector (315). The multi pre-processors (311) includes n number of pre-processor with the input channels having a different ratios.

Each of the pre-processors within the multi pre-processors (311) is equipped with distinct input channels that capture information from the video frames. Prior to transmission to the backbone network (419), the pre-processor undertakes information processing. Each input channel is associated with a range of ratios, including but not limited to d1, d2, d3, d4, d5, and d6, among others. These ratios are variable and can be adjusted to meet specific requirements, contributing to the system's adaptability. Input channels, such as the IPB (103), the QP Slice (401), the QP Base (402), the BS (104), the pred (105), and the rec (106), undergo processing via convolution layers, utilizing various ratios. In an embodiment, a value of d1 may be 192, a value of d2 may be 32, a value of d3 may be 16, a value of d4 may be 16, a value of d5 may be 16, and a value of d6 may be 48, but, it is not limited to the disclosed examples.

The input channel's IPB (103) represents a predicted block based on neighboring pixels within the video frame, while the QP Slice (401) performs the quantization Parameter (QP) for each frame of the video. The QP measures the quality of the quantization process, with higher QP resulting in better quality but also a higher bitrate. The QP Base (402) determines the base QP for the video, which serves as a starting point for determining the QP for each frame. The BS (104) represents the video signal in the frame, while pred (105) reduces the bitrate of each frame by using redundancy between frames. The rec (106) represents the reconstructed pixels after quantization and entropy coding.

To improve the quality of the reconstructed video, the RecEXTY (403) and RecEXTUV (403a) blocks perform reconstruction extension by down-sampling the data and reducing dimensionality. The input channels of the multi pre-processors (311) are passed through convolution layers (404-409) and respective PRELU layers (112) to process the input channels with defined ratios. The combined PRELU layer output is then passed through another convolutional layer (410) and the PRELU layer (430) to further process features from the input channels, contributing to overall transformations and representations in the AILF (318).

Each pre-processor generates an output frame of the video, with an index generated for each pre-processor. The output of the multi pre-processors (311) is input to the pre-processor selector (315) to select the pre-processor having an optimal set of ratios based on the the quality of the video output and the index of the pre-processor. The encoder (316) then encodes and processes the input channels based on the selected pre-processor, informing the decoder (317) of the selected pre-processor.

FIG. 4A shows the assemblage block controller (314) including convolution layers and backbone network. As shown in FIG. 4B, the chosen pre-processor output undergoes a down-sampling operation through Conv 2 3×3 C (418), which utilizes a 3×3 convolutional filter to generate an output with a specific number of channels C. This output then proceeds through the PRELU layer (440), which employs a parametric RELU activation function to identify non-linearity and detect features and patterns that could potentially improve video compression capabilities. Finally, the output passes through the backbone network (419).

FIG. 4C illustrates the backbone network (419) as comprising convolution layers with diverse filtering functions and channels, including but not limited to Conv 1×1 C×C1 (411), Conv 3×1 C×C21 (412), and Conv 1×3 C21×C22 (413). The provided data is processed by these convolution layers (411, 412, and 413) and then passed through the PRELU layer (450). The processed data from the PRELU layer (450) is further passed through Conv 1×1 (C1+C22)×C (414), Conv 1×3 C×C31 (415), and Conv 3×1 C31×C (416) to obtain the number of channels or depth, height, and width of each frame of the video [c h w] (417). In an embodiment, a value of C may be 64, a value of C1 may be 160, a value of C21 may be 32, a value of C22 may be 32, and a value of C31 may be 64, but, it is not limited to the disclosed examples.

Referring back to FIG. 4B, once the backbone network (419) extracts the required information, it passes through another convolution network, Conv 3×3 (420), for feature extraction, followed by the PRELU layer (460) activation function, which introduces adaptability. Subsequently, a second convolutional layer with Conv 3×3, 6 layer (421) is employed for continuous feature extraction. The processed output from Conv 3×3, 6 (421) is then passed through the crop technique (423), which involves extracting a specific region from the input. Pixel shuffling (422) may subsequently be employed, for tasks such as super-resolution or color space transformation.

The Rec UV operation (424) signifies the reconstruction of color information, the U and V Chroma channels, followed by another crop technique (426). The final step involves the reconstruction of the luminance channel (Rec Y) (425). Once the complete process is done, the artifact-removed reconstructed frame of the video is generated. A frame using or merging The Rec UV and the Rec Y may be the frame used in next process or final frame.

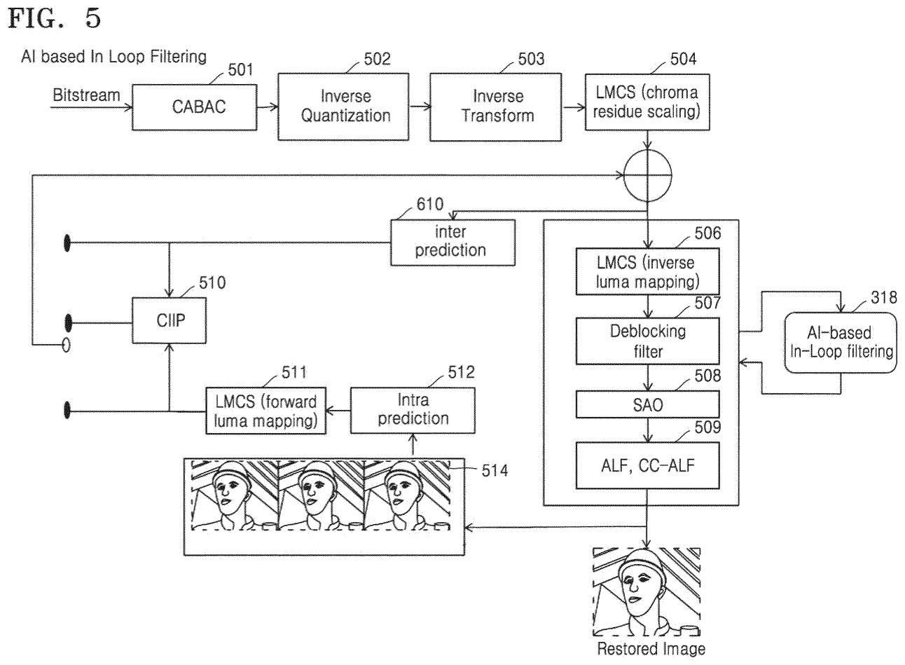

FIG. 5 is a block diagram that illustrates a Versatile Video Codec (VVC) decoder with AILF, according to an embodiment disclosed herein. The AILF (318) pertains to a sophisticated video decoding system. The VVC, a widely accepted video compression standard, relies on the decoder (317) to reconstruct the video frames from the encoded data. With the integration of AILF, cutting-edge AI technology is utilized to enhance the in-loop filtering process, which aims to intelligently improve the video quality by minimizing artifacts and augmenting visual fidelity.

The compressed bitstream is first subjected to processing by a Context-Adaptive Binary Arithmetic Coding (CABAC) (501), which effectively decodes the entropy-encoded data. Next, the decoded information is subjected to the inverse quantization technique (502), which restores transformed coefficients to their original precision. The inverse transform technique (503) is then employed to further reconstruct the spatial representation. Subsequently, a Luma Mapping and Chroma Scaling (Chroma residue scaling) (LMCS) (504) operation is performed. Specifically, the LMCS (504) operation refines the color components, effectively addressing Chroma-related artifacts and contributing to the enhancement of visual quality in the reconstructed video frames.

In video coding, a Closed Intra Prediction (CIIP) (510) technique is utilized for intra-frame compression, which involves making predictions within the same frame. To further enhance the process, the CIIP (510) is combined with the LMCS (Chroma residue scaling) (504) technique. This combination is activated when certain conditions are met or when the circuit is closed. The output of the LMCS (Chroma residue scaling) (504) and the CIIP (510) combined is then fed into the intra prediction technique (610), which estimates pixel values based on neighboring pixels within the frame of the video. The resulting output of the intra prediction technique (610) is then fed back into the CIIP (510), which has the potential to greatly improve the accuracy and quality of the predicted intra-frame content.

The combined output of the LMCS (Chroma residue scaling) (504) and CIIP (510) undergoes a series of processing stages to further refine video decoding. Initially, an LMCS operation is applied for inverse luma mapping (506), aimed at adjusting the luma component in reverse. The video signal then passes through a Deblocking Filter (507) to smooth block boundaries and reduce compression artifacts, followed by Sample Adaptive Offset (SAO) (508) and Adaptive Loop Filter (ALF) with Cross-Component Adaptive Loop Filter (CC-ALF) operations (509). These steps collectively contribute to enhancing the visual quality of the reconstructed frames of the video by addressing various distortions and artifacts in the decoded signal. The AILF (318) is placed strategically between the traditional In-Loop Filters, depending on where the maximum quality reconstructed frames of the video can be realized. The AILF (318) refines the reconstructed frames of the video by reducing noise and artifacts to provide a restored image. It adapts and intelligently adjusts to the decoded picture buffer (514) and input to an Inter prediction technique (512) to efficiently predict image blocks by leveraging information from previous frames. A Forward Luma Mapping through LMCS (511) is used for adjusting the luma component for color and contrast enhancements. Finally, Closed Intra Prediction (CIIP) (510) is employed for intra-frame compression, predicting pixel values within the same frame. These operations collectively contribute to refining the visual quality of the decoded video frames, addressing temporal redundancies and enhancing color representation during the decoding process.

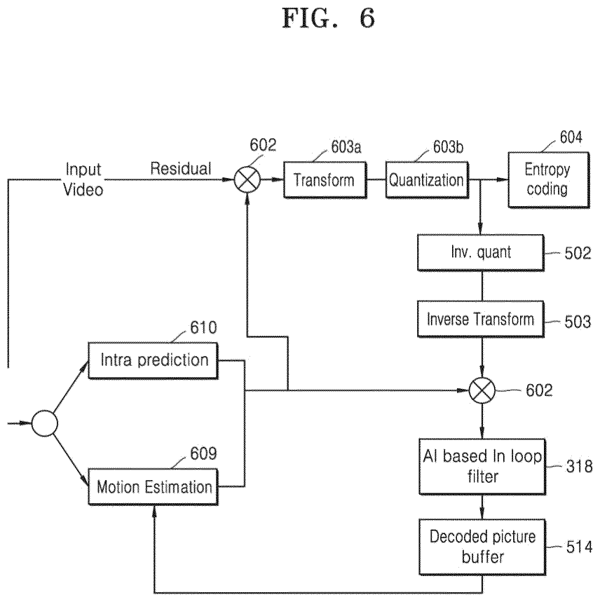

FIG. 6 is a block diagram that illustrates encoder for the VVC, according to the embodiment disclosed herein. The detailed block diagram of the VVC encoder is used to encode the video through encoding process introduced in the VVC encoder block diagram. The video is input to a residual technique (602), an intra prediction technique (610) and a motion estimation technique (609).

The intra prediction technique (610) in video encoding harnesses spatial redundancies within an individual video frame. The intra prediction technique (610) determines the pixel values of each frame of the video (610) by analyzing the values of neighboring pixels in the video. The motion estimation technique (609) identifies and quantifies the motion of the objects between consecutive frames in a video sequence. By detecting the motion of the objects in each frame of the video represents displacement of pixels between frames. The encoder (316) predicts the location of objects in subsequent frames. The motion estimation technique (609) significantly reduces the amount of data needed to describe moving objects in each frame of the video and enhances compression efficiency of the video with video quality.

The output of the intra prediction technique (610) and the motion estimation technique (609) is input to the residual technique (602), the inverse quantization technique (502) and the inverse transform technique (503). The residual technique (602) provides difference between the input video and the intra predicted and motion estimated for each frame of the video. The output of the residual technique (602) is provided as input to a transform technique (603a) and a quantization technique (603b).

The transform technique (603a) transforms the video. Each pixel values of each frame of the video undergone transform operation to transform spatial information into a frequency domain, highlighting important frequency components and allowing for efficient compression. By concentrating signal energy in a reduced set of coefficients, the transform facilitates subsequent quantization for contributing to the overall compression of frame of the video. The transformed video is quantized by dividing into number of frames of the video and generating quantized coefficients for the divided each frames of the video by the quantized technique (603b). The quantized coefficients of each frames of the video reduces the amount of data that needs to be stored and transmitted. An entropy coding technique (604) receives the quantized technique (603b) output as input and removes any statistical redundancy.

The inverse transform technique (503) converts the quantized coefficients into spatial domain pixel values. The quantized coefficients are multiplied by the quantization step size to recover the original transformed coefficients. The inverse quantization technique (502) reduces degree of distortion or loss of information produced by the quantized coefficients in the quantized video. The residual technique (602) differentiates the received inverse quantized frames of the video and combined intra predicted and motion estimation of each frame of the video. The encoded video is passed through the AILF (318) reduces artefacts and improve the visual quality of the video. The AILF (318) operates by smoothing out discontinuities or artefacts that may arise during the compression and decoding process. The AILF (318) processed decoded quality video is stored in the memory by the decoded picture buffer technique (608).

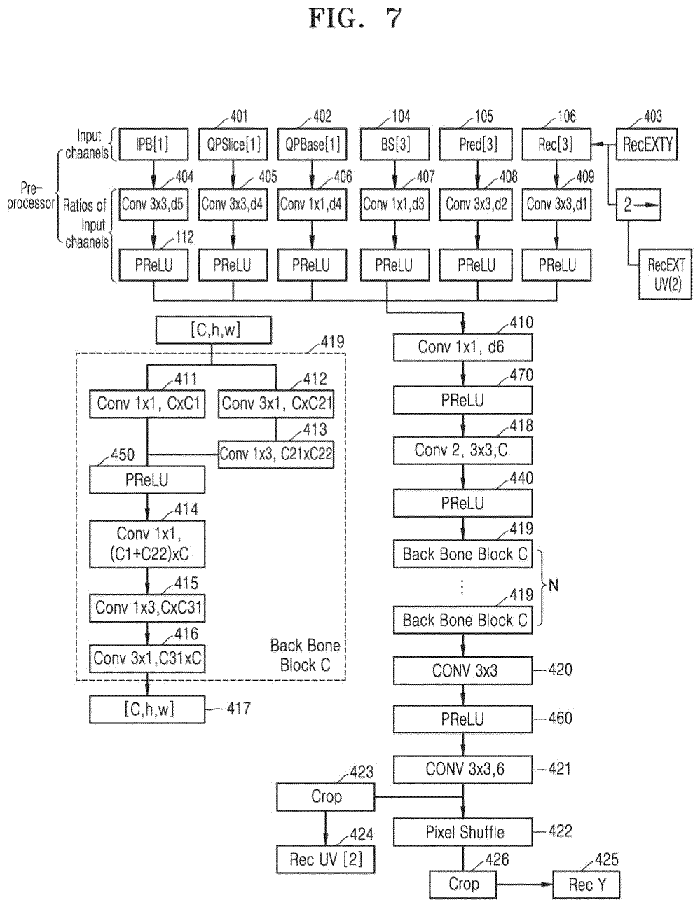

FIG. 7 is a block diagram that illustrates video compressor architecture including pre-processor and the backbone network (419), according to the embodiment disclosed herein. The pre-processors within the multi pre-processors (311) are designed with diverse input channels that carry information derived from frames of the video. Before sending to the backbone network (419), each pre-processor handles and refines input channels. Each input channel in the pre-processor is provided with various ratios, including but not limited to d1, d2, d3, d4, d5, and d6, among others. These ratios can be adjusted based on requirements. Input channels encompass elements like the IPB (103), the QP Slice (401), the QP Base (402), the BS (104), the pred (105), and the rec (106).

The input channels of the multi pre-processors (311) undergo convolutional processing through each pre-processor's convolution layers, including but not limited to Conv 3×3 d5 layer (404), Conv 3×3 d4 layer (405), Conv 1×1 d4 layer (406), Conv 1×1 d3 layer (407), Conv 3×3 d2 layer (408), and Conv 3×3 d1 layer (409), to process the input channels with the defined ratios. Following this, the respective PRELU layer (112) processes the input channels, and their combined output is passed through the Conv 1×1 d6 layer (410) and the PRELU layer (430). The output of each pre-processor and their index are utilized to select the optimal pre-processor from the multi pre-processors (311).

The selected pre-processor output is channeled through the backbone network (419), which comprises convolution layers with a variety of filtering functions and channels, including but not limited to Conv 1×1 C×C1 (411), Conv 3×1 C×C21 (412), Conv 1×3 and C21×C22 (413). These convolution layers (411, 412, and 413) process the provided data and pass it through the PRELU layer (450). The processed data from the PRELU layer (112) is further passed through Conv 1×1 (C1+C22)×C (414), Conv 1×3 C×C31 (415), and Conv 3×1 C31×C (416). The [c h w] (417) is then used to determine the number of channels, depth, height, and width of each frame of the video.

Once the backbone network (419) has processed and extracted the required information, it is passed through the Conv 3×3 layer (420) for feature extraction, followed by the PRELU layer (460) for activation function and adaptability. This is subsequently followed by a second convolutional layer with Conv 3×3 6 layer (421) for continuous feature extraction. The output from the Conv 3×3 6 (421) is then passed through the crop technique (423), which involves extracting a specific region from the input. Pixel shuffling (422) is then employed, potentially for tasks like super-resolution or color space transformation.

The Rec UV operation (424) signifies the reconstruction of color information, the U and V Chroma channels, followed by another crop technique (426). The final step involves the reconstruction of the luminance channel (Rec Y) (425). Once the complete process is done, the artifact-removed reconstructed frame of the video is generated.

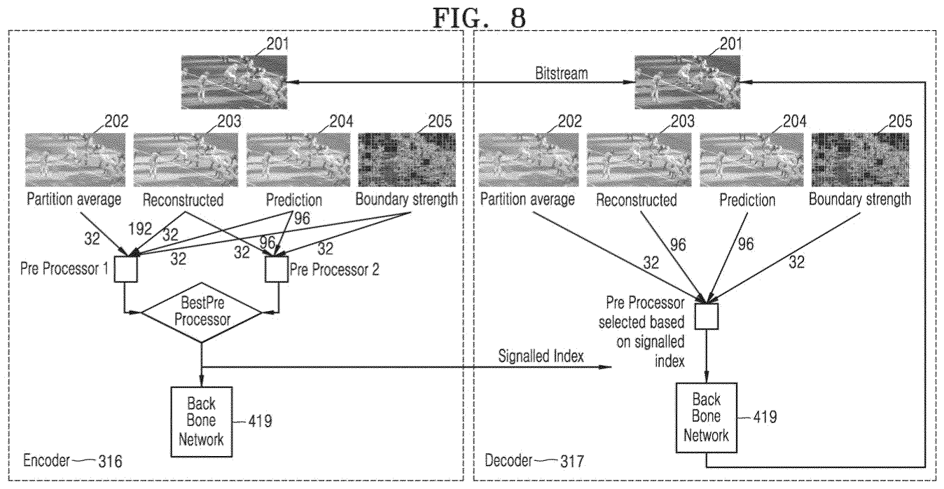

FIG. 8 is a block diagram that illustrates an encoder and a decoder with the pre-processor for video codec, according to the embodiment disclosed herein. Within the encoder (316), the input channels that transmit information from the frames of the video consist of the original patch (201), partition patch (202), reconstructed patch (203), prediction patch (204), and boundary strength patch (205). The video's extracted features are then fed into the pre-processor for processing and optimal output based on the most appropriate feature patch of the video's frames. These inputs are then directed to the multi pre-processors (311), each with varying ratios assigned to their input channels, such as d1, d2, d3, d4, d5, and d6, among others. The ratios are flexible and can be changed according to the need. The pre-processors employ various techniques, as illustrated in FIG. 6, to process the input channels and generate output frames of the video and an index for each pre-processor in the multi pre-processors (311).

The pre-processor selector (315) chooses the optimal pre-processor from the multi pre-processors (311) based on the video's output quality and pre-processor index number. The selected pre-processor index is then signaled to the decoder (317), which is input to the backbone network (419). This network includes convolution layers with various filtering functions and channels (411, 412, 413, 414, 415, 416, and 417). The processed input frames of the video are encoded by the encoder (316) and input into the bitstream.

The decoder (317) uses the selected pre-processor from the multi pre-processors (311) to decode the encoded frames of the video. The decoding process begins with the inverse quantization technique (502), inverse transform technique (503), and inverse prediction, as explained in FIG. 5. The decoded frames of the video are then bit streamed with high-quality frames of the video.

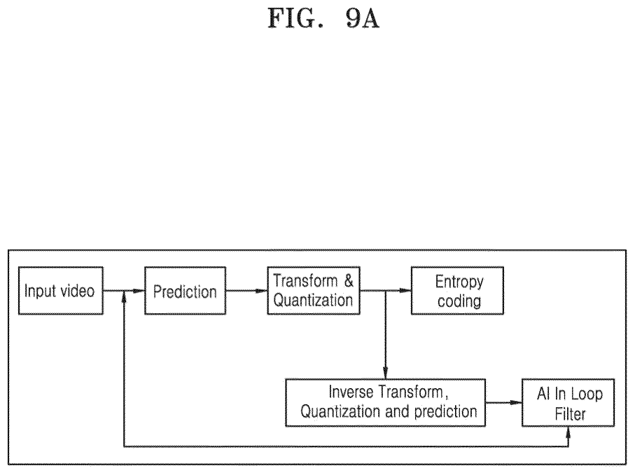

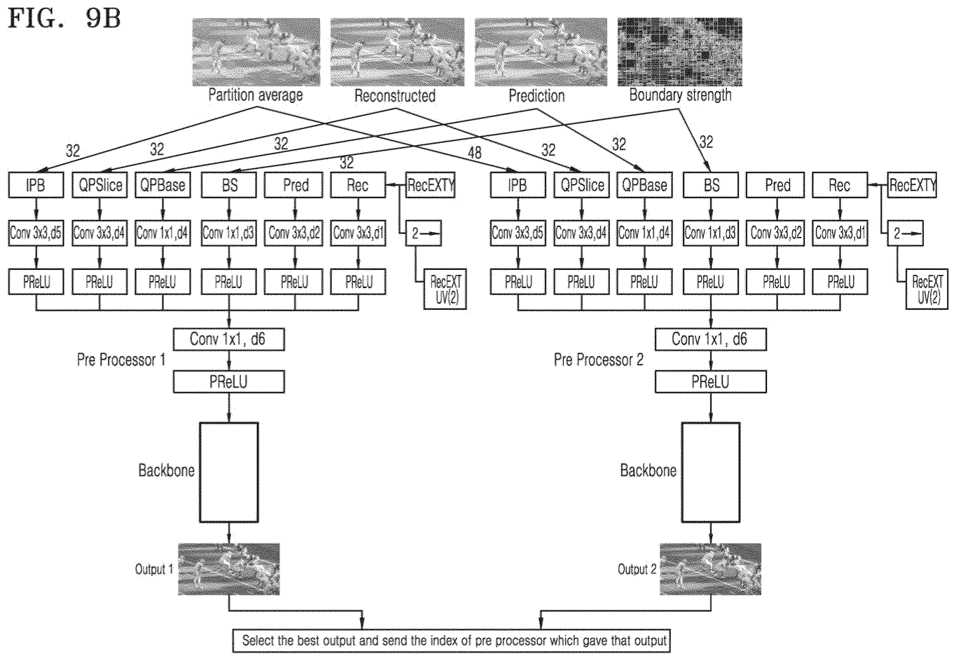

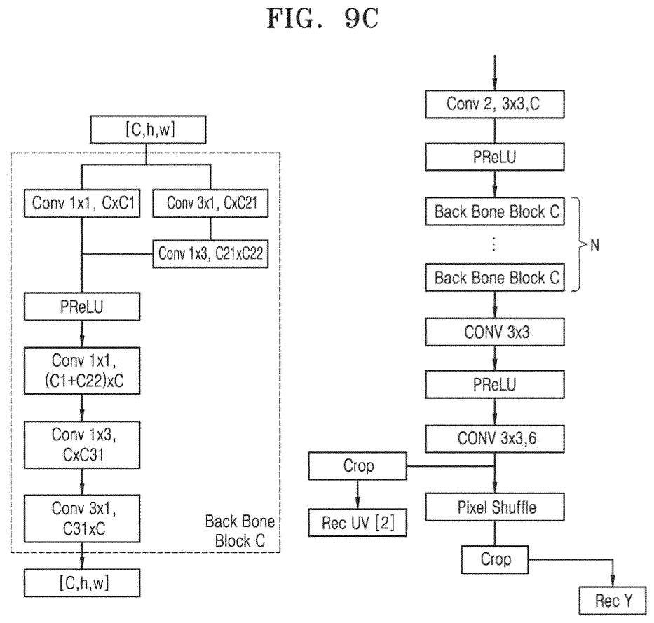

FIG. 9A is a block diagram that illustrates details of the encoder for any codec, according to the embodiment disclosed herein. FIG. 9B is a block diagram that illustrates details of the encoder for any codec, according to the embodiment disclosed herein. FIG. 9C is a block diagram that illustrates details of the encoder for any codec, according to the embodiment disclosed herein.

FIG. 9A is a block diagram that illustrates an encoder for a codec according to an embodiment. The process of encoding includes the selection of frames of the video and process through the multi pre-processors (311). Further, send through the backbone network (419) as disclosed in the FIG. 4. The reconstructed frame of the video, devoid of artifacts, is obtained by utilizing a multi pre-processor system. Each pre-processor is assigned a specific index and the resulting reconstructed frame is fed into the AILF (318). Meanwhile, for convenience of explanation, the in-loop filter that can include AILF is described as AILF. However, AILF may be configured in series or parallel with at least one of LMCS, deblocking filter, SAO, ALF, and CC-ALF included in the in-loop filter, and is not limited to the disclosed example.

FIG. 9B is a block diagram that illustrates the operations performed in AILF according to an embodiment of the disclosure. The AILF (318) then selects the most optimal frame, along with the corresponding index of the pre-processor that produced it. This final output is then directed towards further usage, potentially sent to the decoded picture buffer, while the pre-processor index is directed towards entropy coding for bitstream encoding. This process contributes significantly towards improving the video quality during the decoding process. The block diagram of AILF in FIG. 9b shows operations that can be performed in AI in loop filtering included in in loop filtering after de-quantization and inverse transform are performed, and the output of FIG. 9b is stored in the decoded buffer, or Can be used for prediction of other frames.

The video input utilized in prediction techniques incorporates the intra prediction technique (610) in video encoding, which effectively exploits spatial redundancies within an individual video frame. The intra prediction technique (610) determines the pixel values of each frame of the video by analyzing the values of neighboring pixels in the video. The output of the intra prediction technique (610) is then fed into the video transform technique (603a), which operates on each frame of the video, converting pixel values from spatial information to the frequency domain. This transformation enhances crucial frequency components, enabling efficient compression by concentrating signal energy in a condensed set of coefficients. The transformed video is subsequently quantized, where each frame undergoes division, generating quantized coefficients by the quantization technique (603b). This quantization minimizes the data volume required for storage and transmission. The output from the quantization process (603b) is then fed into the entropy coding technique (604), the inverse transform technique (503), and the inverse quantization technique (502). The entropy coding technique (604) eliminates any statistical redundancy, enhancing the overall compression efficiency of the frames of the video. This technique encodes frames of the video based on the received index of the selected pre-processor.

The technique of inverse transform (503) includes the quantized coefficients with spatial domain pixel values, while the original transformed coefficients are regained by multiplying the quantized coefficients with the quantization step size. The inverse quantization technique (502) effectively mitigates the distortion or loss of information caused by the quantized coefficients in the quantized video. The AILF (318) receives input from the inverse quantization technique (502) and subsequently processes it to furnish an encoded, artifact-free reconstructed frame to the decoded picture buffer.

FIG. 9c is a block diagram that illustrates the backbone network according to an embodiment of the disclosure. The backbone network may be used in AILF after processing by pre-processor. Alternatively, FIG. 4B or 7 are exemplary networks that may be used by the backbone network.

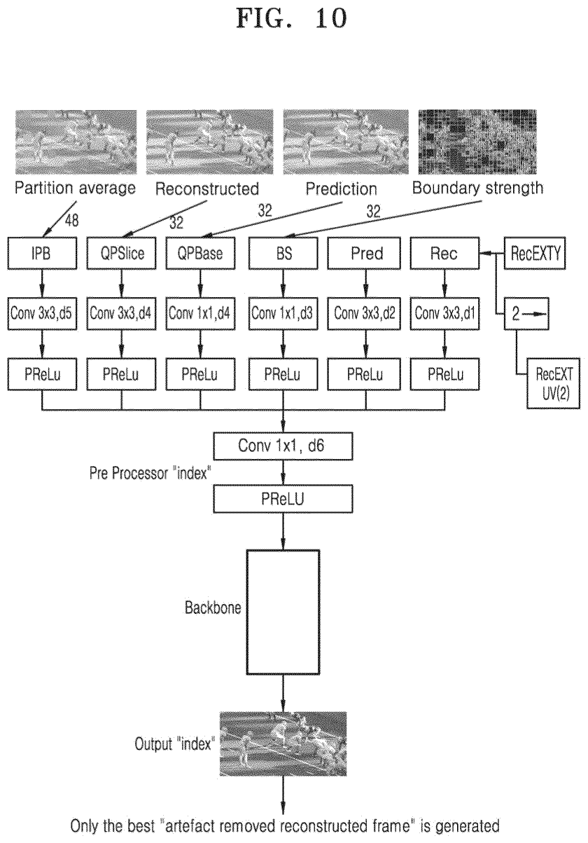

FIG. 10 is a block diagram that illustrates details of the decoder for any codec, according to the embodiment disclosed herein. The decoder (317) receives the selected pre-processor from the multi pre-processors (311) with index and used it for decoding the encoded frames of the video. The electronic device can determine a pre-processor according to the obtained index and obtain a set of ratios for each channel according to the determined pre-processor. Additionally, the obtained set of ratios for each channel can be used for AILF.

The encoded frames of the video passes through the inverse transform technique (503) converts the quantized coefficients into spatial domain pixel values. The quantized coefficients are multiplied by the quantization step size to recover the original transformed coefficients. The inverse quantization technique (502) reduces degree of distortion or loss of information produced by the quantized coefficients. The inverse prediction reconstructs pixel values based on previously encoded frames of the video, aiming to generate the original frames of the video by using predictions from the encoded data.

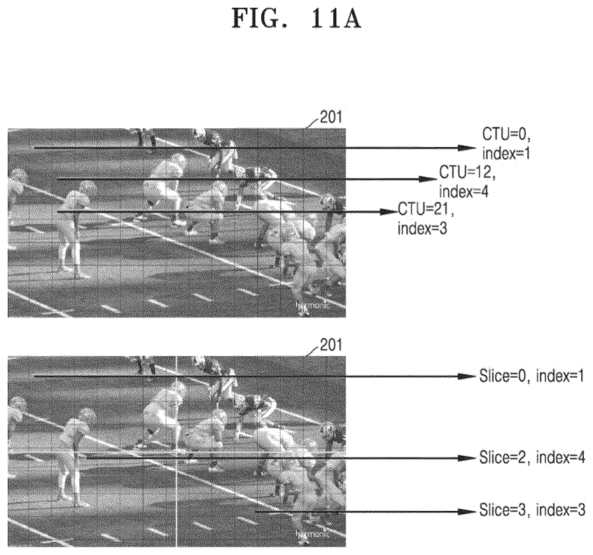

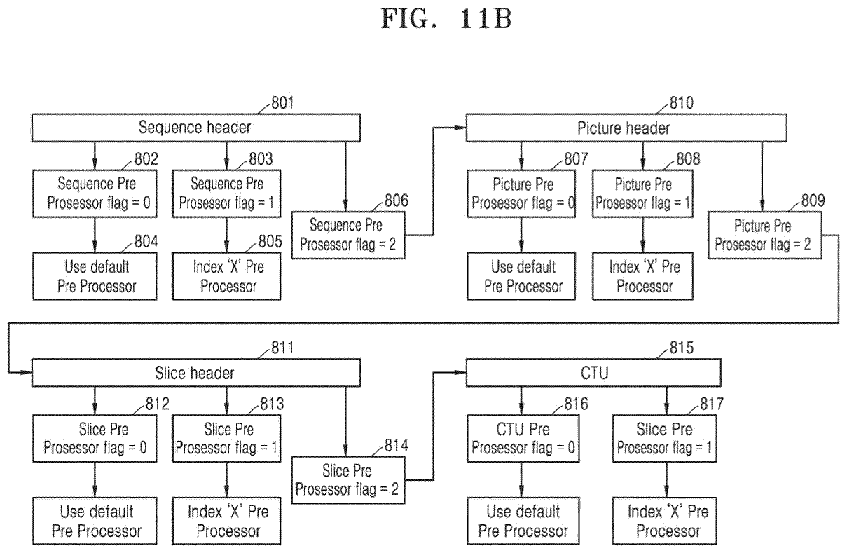

FIG. 11A illustrates an image frame with a CTU and slice numbers, according to the embodiment disclosed herein. Coding Tree Units (CTUs) (815) can derive indices by referencing the context of CTUs (815). Additionally, CTUs (815) may exhibit signaling based on predefined conditions, such as sending an index only when the CTU (815) demonstrates specific characteristics like edge magnitude or variance. In cases where these conditions are not met, default indices, either hardcoded or sent at a higher level of abstraction such as a slice header (811), a picture header (810), and a sequence header (801), are employed. Indices can be transmitted in slice headers (811), the picture header (810), and the sequence header (801), as exemplified in a specific instance within the Picture Parameter Set (PPS). The CTUs (815), the slice header (811), the picture header (810) and the index pertains to the coding parameters or characteristics during encoding process. Meanwhile, when an index for pre-processing is obtained from the sequence header, a pre-processor may be determined for each sequence. If an index for pre-processing is obtained from the picture header, a pre-processor may be determined for each picture. If an index for preprocessing is obtained from the slice header, a preprocessor may be determined for each slice. Alternatively, the pre-processor may be determined for each CTU, or it may be determined for each PU, TU, and CU.

FIG. 11B is a block diagram that illustrates the extracted feature maps with indices, according to the embodiment disclosed herein. The sequence header (801) that incorporates a Sequence Pre-Processor flag is 0 (802). When the flag is set to 0 (802), it signifies the utilization of the default Pre-Processor, while a flag value of 1 (803) indicates the selection of the pre-processor from the multi pre-processors (311) with X indexed (805). Additionally, when the flag is set to 2 (806), it functions as input to the Picture header (810). Similarly, the picture header (810) uses the picture pre-processor flag with 0 or 1 or 2 (807, 808, 809), the slice header (811) uses picture pre-processor flag with 0 or 1 or 2 (812, 813, 814), and CTU (815) uses CTU pre-processor flag with 0 or slice pre-processor flag with 0 or 1.

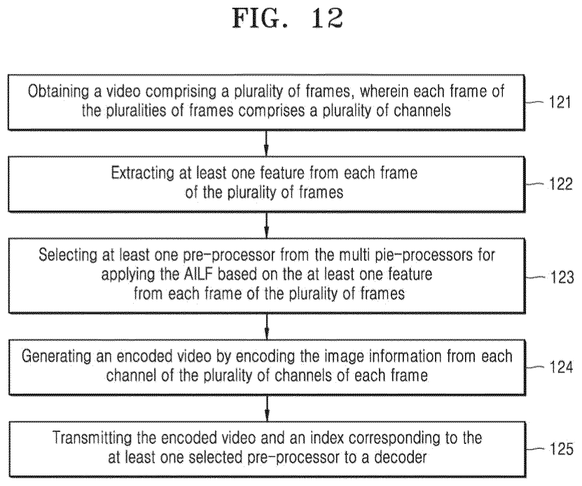

FIG. 12 is a flow diagram illustrating a method for compressing the video using the AI model, according to the embodiment disclosed herein. At step 121, the method includes obtaining a video comprising a plurality of frames, wherein each frame of the pluralities of frames comprises a plurality of channels. Each frames of the plurality of the frames are having image information to be encoded by an encoder (316). The encoding the image information from each channel of the plurality of channels of each frame of the plurality of frames using the at least one selected pre-processor.

At step 122, the method includes extracting at least one feature from each frame of the plurality of frames. The extracted features including the original patch (201), the partition patch (202), the reconstructed patch (203), the prediction patch (204), and the boundary strength of a patch (205). These features serve as inputs to the multi pre-processors (311), which analyses and produces the optimal output based on the most relevant feature patch. The original patch (201) represents unprocessed video data and acts as the baseline for subsequent processes. The partition patch (202) undergoes segmentation, dividing the patch into smaller regions to isolate foreground from background or extract specific features. The reconstructed patch (203) results from reconstructing the video to a bitstream using information from patches, including the partition patch (202) and the prediction patch (204). The prediction patch (204) anticipates the original patch (201) based on available information, enhancing the quality of the reconstructed patch (203). The boundary strength of patch (205) indicates confidence in patch boundaries, crucial for segmentation, object detection, or motion estimation, with higher strength indicating a clearer distinction between regions in the reconstructed patch (203).

At step 123, the method includes selecting at least one pre-processor from the multi pre-processors (311) for applying the AILF (318) based on the at least one feature from each frame of the plurality of frames. Each pre-processor of the multi pre-processors (311) comprises a set of ratios each of which corresponds to each channel of the plurality of frames of each frame of the plurality of frames, and wherein the at least one selected pre-processor (311) comprises an optimal set of ratios for encoding the image information from each channel. The electronic device may select the at least one pre-processor from the multi pre-processors for applying the AILF to enhance the each frame of the pluralities of frames.

At step 124, the method may include generating an encoded video by encoding the image information from each channel of the plurality of channels of each frame of the plurality of frames using the at least one selected pre-processor for the AILF (318). The method includes generating an encoded video by encoding the frame of the video at an AI-based In Loop stage. In this step, the intra prediction technique (610) and inter prediction technique (512) processes. Subsequently, it performs transformation and quantization on the video blocks based on the predictions. The device generates quantized coefficients for the frames of the video. Following this, it reconstructs the frames of the video using the produced quantized coefficients. The reconstructed video is then transmitted through the AILF (318) for artifact removal, resulting in the artifact-free reconstructed video. The electronic device perform in-loop filtering the reconstructed video with AILF to get an artefact removed reconstructed video, wherein the artefact removed reconstructed video is quality enhanced video. And, the electronic device may perform entropy coding to encode the artefact removed reconstructed video.

At step 125, the method includes transmitting the encoded video and an index corresponding to the at least one selected pre-processor to a decoder. The decoder (317) receives the selected pre-processor from the multi pre-processors (311) with index and used it for decoding the encoded frames of the video. The encoded frames of the video passes through the inverse transform technique (503), transforming quantized coefficients back into spatial domain pixel values. By multiplying the quantized coefficients with the quantization step size, the original transformed coefficients are recovered. The inverse quantization technique (502) minimizes distortion or loss of information caused by the quantized coefficients. Additionally, the inverse prediction reconstructs pixel values by utilizing information from previously encoded frames, with the goal of generating the original frames of the video through predictions derived from the encoded data.

In an embodiment of the disclosure, the objectives are achieved by providing a method managing multi pre-processors for AILF. The method includes receiving, by an electronic device, a video comprising a plurality of frames. Each of the frames includes a plurality of channels before applying the AILF and each of the channels includes image information to be encoded by an encoder of the electronic device. Further, the method includes extracting, by the electronic device, at least one feature from each frame of the plurality of frames of the video. Further, the method includes selecting, by the electronic device, at least one pre-processor from the multi pre-processors for applying the AILF to enhance the encoding the image information. The pre-processors are selected based on the at least one extracted features. Each pre-processor of the multi pre-processors comprises a set of ratios each of which corresponds to each channel of the plurality of frames of each frame of the plurality of frames, and wherein the at least one selected pre-processor comprises an optimal set of ratios for encoding the image information from each channel. The method includes generating, by the electronic device, an encoded video by encoding the image information from each channel of the plurality of channels of each frame of the plurality of frames using the at least one selected pre-processor. The method includes transmitting, by the electronic device, the encoded video and an index corresponding to the at least one selected pre-processor to a decoder of the electronic device.

In an embodiment, encoding the image information from each channel of the plurality of channels of each frame of the plurality of frames at AI based In Loop stage at an AI-based in loop stage. The encoding includes dividing the received video into various blocks to perform an intra prediction and an inter prediction. Further, performing transformation and quantization based on the intra predicted and the inter predicted video blocks and generating quantized coefficients for the divided video blocks which have undergone the intra prediction and the inter prediction. Further, reconstructing the divided video blocks based on the generated quantized coefficients. Further, sending the reconstructed video through the AI model to get an artefact removed reconstructed video and sending the artefact removed reconstructed video through entropy coding to encode.

In an embodiment, the method includes receiving the encoded video, and the index corresponding to the at least one selected pre-processor for determining the at least one selected pre-processor for decoding the encoded video based on the index corresponding to the at least one selected pre-processor and decoding the encoded video using the optimal set of ratios of the at least one selected pre-processor.

In an embodiment, encoding the image information from each channel of the plurality of channels of each frame of the plurality of frames using the at least one selected pre-processor comprises embedding the optimal set of ratios of the at least one selected pre-processor into the encoded image information for use by the decoder for decoding of the encoded video and inputting the pre-processed image information from each channel and the frame to the AI in-loop filter for generating the encoded video.

In an embodiment, the optimal set of ratios of the at least one selected pre-processor is embedded in at least one of a sequence header, a picture header, a slice header, and a Coding Tree Unit (CTU) of each frame of the plurality of frames.

In an embodiment, the plurality of channels comprises, a luma reconstruction, a prediction buffer, a boundary strength, a Quantization Parameter (QP) base, a QP Slice, and a block coding type.

Accordingly, the embodiment herein is to provide an electronic device for managing multi pre-processors for AILF in a video codec. The electronic device comprises the multi pre-processors connected to an encoder and a decoder, a memory comprising a video to be encoded, an assemblage block controller, coupled to the memory and the multi pre-processors. The assemblage block controller is configured to receive a video comprising a plurality of frames. Each of the frames includes a plurality of channels before applying the AILF and each of the channels includes image information to be encoded by an encoder of the electronic device. Further, extract at least one feature from each frame of the plurality of frames of the video. Further, the assemblage block controller selects at least one pre-processor from the multi pre-processors for applying the AILF based the at least one extracted features. Each of the multi pre-processors includes a set of ratios each of which corresponds to each channel of the plurality of frames of each frame of the plurality of frames. The selected pre-processor includes an optimal set of ratios for encoding the image information from each channel. The electronic device may the assemblage block controller generates an encoded video by encoding the image information from each channel of the plurality of channels of each frame of the plurality of frames using the at least one selected pre-processor for the AILF. The electronic device may transmit the encoded video and an index corresponding to the at least one selected pre-processor to a decoder of the electronic device.

In an embodiment of the disclosure, a method for managing multi pre-processors (311) for an AI-based In Loop Filter (AILF) (318) in a video codec, may include obtaining, by an electronic device (310), a video comprising a plurality of frames, wherein each frame of the pluralities of frames comprises a plurality of channels before applying the AILF (318), and wherein each of the channels comprises image information. The method may include extracting, by the electronic device (310), at least one feature from each frame of the plurality of frames. The method may include selecting, by the electronic device (30), at least one pre-processor from the multi pre-processors (311) for applying the AILF (318) based on the at least one extracted feature, wherein each pre-processor of the multi pre-processors (311) comprises a set of ratios each of which corresponds to each channel of the plurality of channels of each frame of the plurality of frames. The method may include generating, by the electronic device (310), an encoded video by encoding the image information from each channel of the plurality of channels of each frame of the plurality of frames using the at least one selected pre-processor for the AILF (318). The method may include transmitting, by the electronic device (310), the encoded video and an index corresponding to the at least one selected pre-processor to a decoder.

In an embodiment of the disclosure, the method may include dividing, by the electronic device (310), the received video into various blocks to perform an intra prediction and an inter prediction. The method may include performing, by the electronic device (310), a transformation (603a) of the video blocks based on the intra predicted and the inter predicted video blocks. The method may include performing, by the electronic device (310), a quantization (603b) on the video blocks based on the intra predicted (610) and the inter predicted (512) video blocks. The method may include generating, by the electronic device (310), quantized coefficients for the divided video blocks which have undergone the intra prediction (610) and the inter prediction (512), wherein the quantization divides the transformed video blocks and generates the quantized coefficients. The method may include reconstructing, by the electronic device (310), the divided video blocks based on the generated quantized coefficients. The method may include performing by the electronic device (310), in-loop filtering the reconstructed video with the AILF (318) to get an artefact removed reconstructed video, wherein the artefact removed reconstructed video is quality enhanced video. The method may include performing, by the electronic device (310), entropy coding (604) to encode the artefact removed reconstructed video.

In an embodiment of the disclosure, the method may include embedding, by the electronic device (310), the set of ratios of the at least one selected pre-processor into the encoded image information. The method may include inputting, by the electronic device (310), the pre-processed image information from each channel and the frame to the AILF (318).

In an embodiment of the disclosure, the set of ratios for the at least one selected pre-processor may be embedded in at least one of a sequence header (801), a picture header (810), a slice header (811), and a Coding Tree Unit (CTU) (815) of each frame of the plurality of frames.

In an embodiment of the disclosure, the plurality of channels may comprise a luma reconstruction, a prediction buffer (105), a boundary strength patch (205), a Quantization Parameter (QP) base (402), a QP Slice (401), and a block coding type.

In an embodiment of the disclosure, the method may include performing AILF after at least one of LMCS, deblocking filtering, SAO, ALF, and CC-ALF is performed.

In an embodiment of the disclosure, the at least one feature from each frame of the plurality of frames is pre-defined.

In an embodiment of the disclosure, a method for managing multi pre-processors (311) for an AI-based In Loop Filter(AILF) (318) in a video codec, may include obtaining, by an electronic device (310), encoded video and index corresponding to at least one selected pre-processor. The method may include determining, by the electronic device (310), the at least one selected pre-processor for decoding the encoded video based on the index corresponding to the at least one selected pre-processor. The method may include decoding, by the electronic device (310), the encoded video using a set of ratios of the at least one selected pre-processor.

In an embodiment of the disclosure, an electronic device (310) for managing multi pre-processors (311) for an AI-based In Loop Filter (AILF) (318) in a video codec, comprising: a memory (313) comprising a video to be encoded and storing one or more instructions; and at least one processor including the multi pre-processors (311), configured to execute the one or more instructions. The at least one processor may be configured to execute the one or more instructions to obtain a video comprising a plurality of frames, wherein each frame of the pluralities of frames comprises a plurality of channels before applying the AILF (318), and wherein each of the channels comprises image information. The at least one processor may be configured to extract at least one feature from each frame of the plurality of frames. The at least one processor may be configured to select at least one pre-processor from the multi pre-processors (311) for applying the AILF (318) based on the at least one extracted feature, wherein each pre-processor of the multi pre-processors (311) comprises a set of ratios each of which corresponds to each channel of the plurality of frames of each frame of the plurality of frames. The at least one processor may be configured to generate an encoded video by encoding the image information from each channel of the plurality of channels of each frame of the plurality of frames using the at least one selected pre-processor for the AILF (318). The at least one processor may be configured to transmit the encoded video and an index corresponding to the at least one selected pre-processor to a decoder.

In an embodiment of the disclosure, the at least one processor is configured to divide the received video into various blocks to perform an intra prediction and an inter prediction. The at least one processor is configured to perform a transformation (603a) of the video blocks based on the intra predicted and the inter predicted video blocks. The at least one processor is configured to perform a quantization (603b) on the video blocks based on the intra predicted (610) and the inter predicted (512) video blocks. The at least one processor is configured to generate quantized coefficients for the divided video blocks which have undergone the intra prediction (610) and the inter prediction (512), wherein the quantization divides the transformed video blocks and generates the quantized coefficients. The at least one processor is configured to reconstruct the divided video blocks based on the generated quantized coefficients. The at least one processor is configured to perform in-loop filtering the reconstructed video with the AILF (318) to get an artefact removed reconstructed video, wherein the artefact removed reconstructed video is quality enhanced video. The at least one processor is configured to perform entropy coding (604) to encode the artefact removed reconstructed video through entropy coding (604) to encode.

In an embodiment of the disclosure, the at least one processor is configured to embed the set of ratios of the at least one selected pre-processor into the encoded image information. The at least one processor is configured to input the pre-processed image information from each channel and the frame to an AILF (318).

In an embodiment of the disclosure, the set of ratios for the at least one selected pre-processor is embedded in at least one of a sequence header (801), a picture header (810), a slice header (811), and a Coding Tree Unit (CTU) (815) of each frame of the plurality of frames.

In an embodiment of the disclosure, the plurality of channels comprises a luma reconstruction, a prediction buffer (105), a boundary strength patch (205), a Quantization Parameter (QP) base (402), a QP Slice (401), and a block coding type.

In an embodiment of the disclosure, the at least one processor is configured to perform AILF after at least one of LMCS, deblocking filtering, SAO, ALF, and CC-ALF is performed.

In an embodiment of the disclosure, the at least one feature from each frame of the plurality of frames is pre-defined.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

What is claimed is:

1. A method for managing multi pre-processors for an AI-based In Loop Filter (AILF) in a video codec, comprising:
obtaining, by an electronic device, a video comprising a plurality of frames, wherein each frame of the plurality of frames comprises a plurality of channels, and
wherein each channel of the plurality of frames comprises image information;
extracting, by the electronic device, at least one feature from each frame of the plurality of frames;
selecting, by the electronic device, at least one pre-processor from the multi pre-processors for applying the AILF based on the at least one extracted feature, wherein each pre-processor of the multi pre-processors comprises a set of ratios,
wherein each ratio of each set of ratios corresponds to each channel of the plurality of channels;
generating, by the electronic device, an encoded video by encoding the image information from each channel of the plurality of channels using the at least one selected pre-processor; and
transmitting, by the electronic device, the encoded video and an index corresponding to the at least one selected pre-processor to a decoder.

2. The method of claim 1, wherein the encoding of the image information from each channel using the at least one selected pre-processor comprises:
dividing, by the electronic device, the obtained video into video blocks;
performing intra prediction and inter prediction based on the video blocks;
performing, by the electronic device, a transformation of the video blocks based on the intra prediction and the inter prediction;
performing, by the electronic device, a quantization on the video blocks based on the intra prediction and the inter prediction;
generating, by the electronic device, quantized coefficients for the video blocks based on the intra prediction and the inter prediction, wherein the quantization divides the transformed video blocks and generates the quantized coefficients;
reconstructing, by the electronic device, the video based on the quantized coefficients;
performing, by the electronic device, in-loop filtering of the reconstructed video with the AILF to remove at least one artifact from the reconstructed video; and
performing, by the electronic device, entropy coding to encode the filtered reconstructed video.

3. The method of claim 1, wherein the encoding of the image information from each channel using the at least one selected pre-processor comprises:
embedding, by the electronic device, the set of ratios of the at least one selected pre-processor into the encoded image information; and
inputting, by the electronic device, the encoded image information from each channel and the plurality of frames to the AILF.

4. The method of claim 1, wherein the set of ratios for the at least one selected pre-processor is embedded in at least one of a sequence header, a picture header, a slice header, and a Coding Tree Unit (CTU) of each frame of the plurality of frames.

5. The method of claim 1, wherein the plurality of channels comprises a luma reconstruction, a prediction buffer, a boundary strength patch, a Quantization Parameter (QP) base, a QP Slice, and a block coding type.

6. The method of claim 2, wherein the performing of the in-loop filtering of the reconstructed video with the AILF comprises:
performing the AILF after at least one of Luma Mapping and Chroma Scaling (LMCS), deblocking filtering, Sample Adaptive Offsetting (SAO), Adaptive Loop Filtering (ALF), and Cross-Component Adaptive Loop Filtering (CC-ALF) is performed.

7. The method of claim 1, wherein the at least one feature from each frame of the plurality of frames is pre-defined.

8. A method for managing multi pre-processors for an AI-based In Loop Filter (AILF) in a video codec, comprising:
obtaining, by an electronic device, an encoded video and an index corresponding to at least one selected pre-processor;
determining, by the electronic device, the at least one selected pre-processor for decoding the encoded video based on the index corresponding to the at least one selected pre-processor; and
decoding, by the electronic device, the encoded video using a set of ratios of the at least one selected pre-processor.

9. An electronic device for managing multi pre-processors for an AI-based In Loop Filter (AILF) in a video codec, comprising:
memory configured to store one or more instructions; and
at least one processor comprising the multi pre-processors, wherein the at least one processor is configured to execute the one or more instructions to cause the electronic device to:
obtain a video comprising a plurality of frames, wherein each frame of the plurality of frames comprises a plurality of channels, wherein each channel of the plurality of channels comprises image information;
extract at least one feature from each frame of the plurality of frames;
select at least one pre-processor from the multi pre-processors for applying the AILF based on the at least one extracted feature, wherein each pre-processor of the multi pre-processors comprises a set of ratios,
wherein each ratio of each set of ratios corresponds to the plurality of channels;
generate an encoded video by encoding the image information from each channel of the plurality of channels using the at least one selected pre-processor; and
transmit the encoded video and an index corresponding to the at least one selected pre-processor to a decoder.

10. The electronic device of claim 9, wherein the at least one processor is configured to execute the one or more instructions to cause the electronic device to:
divide the obtained video into video blocks;
perform intra prediction and inter prediction based on the video blocks;
perform a transformation of the video blocks based on the intra prediction and the inter prediction;
perform a quantization on the video blocks based on the intra prediction and the inter prediction;
generate quantized coefficients for the video blocks based on the intra prediction and the inter prediction, wherein the quantization divides the transformed video blocks and the generates the quantized coefficients;
reconstruct the video blocks based on the quantized coefficients;
perform in-loop filtering of the reconstructed video with the AILF to remove at least one artifact from the reconstructed video; and
encode the filtered reconstructed video through entropy coding.

11. The electronic device claim 9, wherein the at least one processor is configured to execute the one or more instructions to cause the electronic device to:
embed the set of ratios of the at least one selected pre-processor into the encoded image information; and
input the encoded image information from each channel and the plurality of frames to the AILF.

12. The electronic device claim 9, wherein the set of ratios for the at least one selected pre-processor is embedded in at least one of a sequence header, a picture header, a slice header, and a Coding Tree Unit (CTU) of each frame of the plurality of frames.

13. The electronic device claim 9, wherein the plurality of channels comprises a luma reconstruction, a prediction buffer, a boundary strength patch, a Quantization Parameter (QP) base, a QP Slice, and a block coding type.

14. The electronic device claim 10, wherein the performing of the in-loop filtering of the reconstructed video with the AILF comprises:
performing the AILF after at least one of Luma Mapping and Chroma Scaling (LMCS), deblocking filtering, Sample Adaptive Offsetting (SAO), Adaptive Loop Filtering (ALF), and Cross-Component Adaptive Loop Filtering (CC-ALF) is performed.

15. The electronic device of claim 9, wherein the at least one feature from each frame of the plurality of frames is pre-defined.

16. The method of claim 1, wherein each set of ratios is variable.

17. The method of claim 1, wherein the at least one selected pre-processor is selected from the multi pre-processors based on a quality of the video and the index corresponding to the at least one selected pre-processor.

18. The method of claim 8, wherein the determining the at least one selected pre-processor for decoding the encoded video is based on the quality of a video output.

19. The electronic device of claim 9, wherein each set of ratios is variable.

20. The electronic device of claim 9, wherein the at least one selected pre-processor is selected from the multi pre-processors based on a quality of the video and the index corresponding to the at least one selected pre-processor.
